(19) United States
(12) Patent Application Publication
(10) Pub. No.: US 2011/0023237 A1
(43) Pub. Date: Feb. 3, 2011

(54) Multi-purpose hand held tool

(76) Inventor: Jerry A. Simmons, Montgomery, TX (US)

Correspondence Address: THE MATTHEWS FIRM, 2000 BERING DRIVE, SUITE 700, HOUSTON, TX, 77057, US

(21) Appl. No.: 12/925,007

(22) Filed: Oct. 12, 2010

Related U.S. Application Data
(63) Continuation-in-part of application No. 12/011,688, filed on Jan. 29, 2008, now Pat. No. 7,836,534.

(51) Int. Cl. B25F 1/00; B25B 25/00

(52) U.S. Cl. 7/117

(57) ABSTRACT

A multi-purpose hand held tool is provided which allows an individual to perform several tasks and reduces the need for additional tools. Specifically, the tool includes a hammer and a claw with an extension providing additional leverage to the claw for prying objects apart and for pulling nails. Additionally, the tool provides a ring and catches useful for pulling fence wiring, such as barbed wire during the installation of a fence.

### CROSS REFERENCE TO RELATED APPLICATIONS

The present application is a continuation-in-part application, claiming priority to the co-pending United States patent application entitled “Multi-Purpose Hand Held Tool” and bearing Ser. No. 12/011,688, filed Jan. 29, 2008, the entirety of which is incorporated herein by reference.

### BACKGROUND OF THE INVENTION

### Field of the Invention

This present invention relates, generally, to hand tools and methods for using the same. More specifically, the present invention relates to a multi-purpose hand tool usable for a variety of tasks, such as manipulating barbed wire and other elongate members usable in the construction of fences and other barricade systems.

### BRIEF DESCRIPTION OF THE DRAWINGS

The drawings contained herein exemplify a preferred embodiment of the claimed invention. It should be noted that the invention is not limited to the embodiment shown. The embodiment shown is purely an example, and the invention is capable of variations of said embodiment. In the drawings:

FIG. 1 is a side view of an embodiment of a multi-purpose tool usable within the scope of the present disclosure.

FIG. 2 is a front view of the multi-purpose tool of FIG. 1.

FIG. 3 is a top view of the multi-purpose tool of FIG. 1.

FIG. 4 is an elevated isometric view of the multi-purpose tool of FIG. 1.

FIG. 5 is a side view of an alternate embodiment of a multi-purpose tool usable within the scope of the present disclosure.

### DETAILED DESCRIPTION OF THE INVENTION

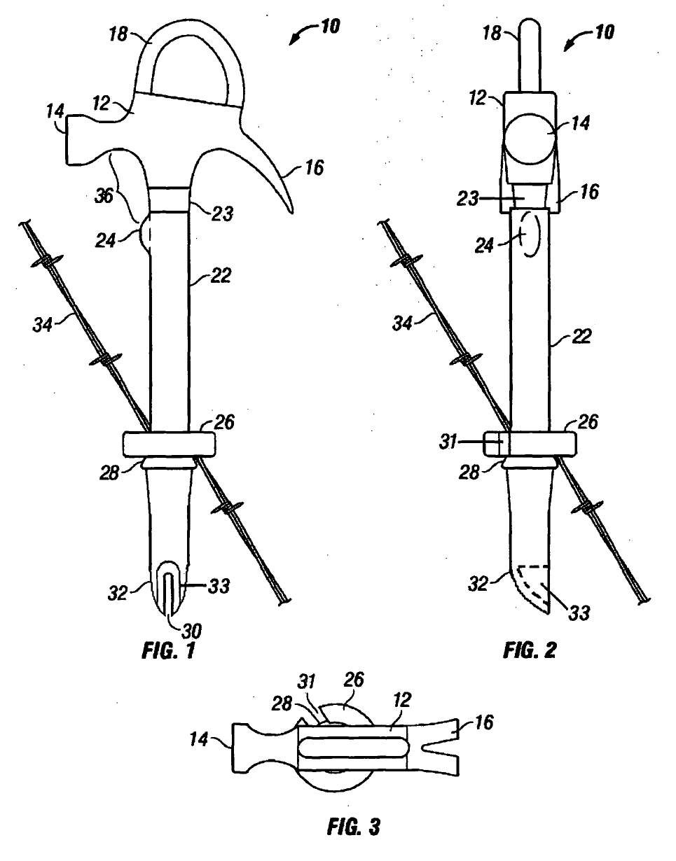

FIG. 1 through FIG. 4 illustrate an embodiment of a multi-purpose tool 10. It should be understood by those skilled in the art that the material for manufacturing any portion of the tool 10 can vary and can include a variety of materials such as, but not limited to, steel, wood, plastics, fiber glass, magnetic materials, polymers, composites, or any combinations thereof.

The depicted embodiment of the tool 10 is shown having a head 12 with a striking surface 14, usable to drive nails, posts, dowels, or similar items, to shape deformable objects, to break frangible objects, and other similar tasks, facilitated by the weight and density of the head 12. For example, in an embodiment, the head 12 can be a generally solid member, formed from steel or a similar member. The head 12 is further shown having a claw 16 disposed opposite the striking surface 14. The claw 16 is shown having two prongs separated by a generally V-shaped slot, however other shapes and configurations known in the art are also usable. The claw 16 is usable for pulling and/or removing nails, some varieties of screws, staples, and the like through use of the shaft 22 of the tool 10 as a lever arm, facilitated by the length and curvature of the claw 16. The head 12 is further shown having a generally semi-circular loop 18 attached thereto and/or integral therewith. In various embodiments, the loop can be integral with the head 12, welded or glued thereto, or attached to the head 12 in any other manner known in the art. In an embodiment of the invention, the loop 18 can be sized for engagement with a T-post or a similar member of a fence or barricade, and used to pull, straighten, and/or remove such a member. The loop 18 is also usable a hanger for the tool 10 when not in use, such as by placing the loop 18 over a nail, hook, or similar object. The tool 10 can also be hung from a tool belt, wearable hook, strap, or the like to facilitate carrying of the tool. The loop 18 is also usable to provide additional leverage when pulling a nail or similar object.

While conventional hammers typically provide a curved claw that extends to a curved portion at the top of the hammer head to define a fulcrum point, the loop 18 provides a different path for the head 12 to roll while pulling a nail in a single motion, due to the fact that the loop 18 extends farther beyond the top of the tool 10 than the head of a conventional hammer. The extra distance provided by loop 18 increases the distance between the fulcrum point and the nail being pulled, resulting in a mechanical advantage when compared to conventional hammer heads, because less movement of the handle is required to generate the same displacement of the claw 16 and the nail being pulled.

Additionally, the extension provided by the loop 18 allows the claw 16 to remain in pulling contact with the nail for a greater distance, which is of great use when pulling a longer nail or similar item. Smaller conventional hammerheads begin to lose vertical pulling power when pulling longer nails. Thus, the loop 18 of the tool 10 enables the pulling of nails of substantially any length with more ease and accuracy. The loop 18 can also be used in conjunction with the handle for pulling a “come-a-long” cable attached to a hook.

The head 12 is shown mounted on an elongate member 22. The elongate member 22 is depicted as a shaft with a first end and a second end, usable as a handle and to provide leverage for numerous purposes. The method of attachment between the head 12 and the handle 22 can include any manner of welding, integral construction, use of adhesives, screws, bolts, nails, or other fasteners, or any other method of attachment known in the art.

FIGS. 1 through 4 further depict a ring 26 disposed around the elongate member 22 for use as a wire stretcher, such as when erecting a barbed wire fence or a similar type of barricade having flexible members tensioned between posts or other fixed members. For illustrative purposes, FIGS. 1 and 2 show a length of barbed wire 34 being stretched by the tool 10.

The ring 26 is axially movable along and rotatable about the elongate member 22. A notch 31 in the ring 26 enables the wire 34 to be placed between the ring 26 and the elongate member 22. The notch 31 further enables the ring 26 to be removed from the elongate member 22. Specifically, the elongate member 22 is shown having a depressed region 23 formed thereon. The notch 31 of the ring 26 and the depressed region 23 of the elongate member 22 are sized such that when the notch 31 is aligned with the depressed region 23, the depressed region 23 may pass through the notch 31 such that the ring 26 can be selectively removed or associated with the elongate member 22. In further embodiments of the disclosure, the ring 26 and/or the elongate member 22 can be magnetized to facilitate retention of the ring 26 in a generally stationary orientation when not in use.

While the head 12 of the tool ultimately limits axial movement of the ring 26, the elongate member 22 is also shown having a protrusion 24 formed thereon. The protrusion 24 serves as a ring holder, further limiting the axial movement of the ring 26. In an embodiment, the notch 31 and protrusion 24 can be sized to permit the ring 26 to be passed over the notch 31 when the notch 31 is aligned with the protrusion 24. When the notch 31 is not aligned with the protrusion 24, the protrusion 24 will interfere with axial movement of the ring 26, such that the ring 26 remains within a space 36 defined between the protrusion 24 and the head 12, thereby preventing the ring 26 from interfering with a user's hand while manipulating the tool 10. It should be understood that the elongate member 22 can include any number of protrusions, positioned at any point thereon. The elongate member 22 is also shown having a stopper 28 formed thereon, having a generally conical shape. The stopper 28 also serves to limit movement of the ring 26 along the elongate member 22. Use of the ring 26, stopper 28, and elongate member 22 as a wire-stretching tool is described below.

At the end of the elongate handle 22 a pry bar 32 is shown, which includes a generally wedge-shaped member, having a slot 38 therein to define two prongs. The wedge shape of the pry bar 32 can narrow to a generally flat face, enabling the pry bar 32 to be forced between objects. The depicted pry bar 32 is shown having side walls 33 surrounding a depressed region formed at the end of the elongate member 22, further enabling the pry bar 32 to be used to engage and stretch a length of barbed wire or a similar flexible object by engaging a barb or other enlarged region between the prongs.

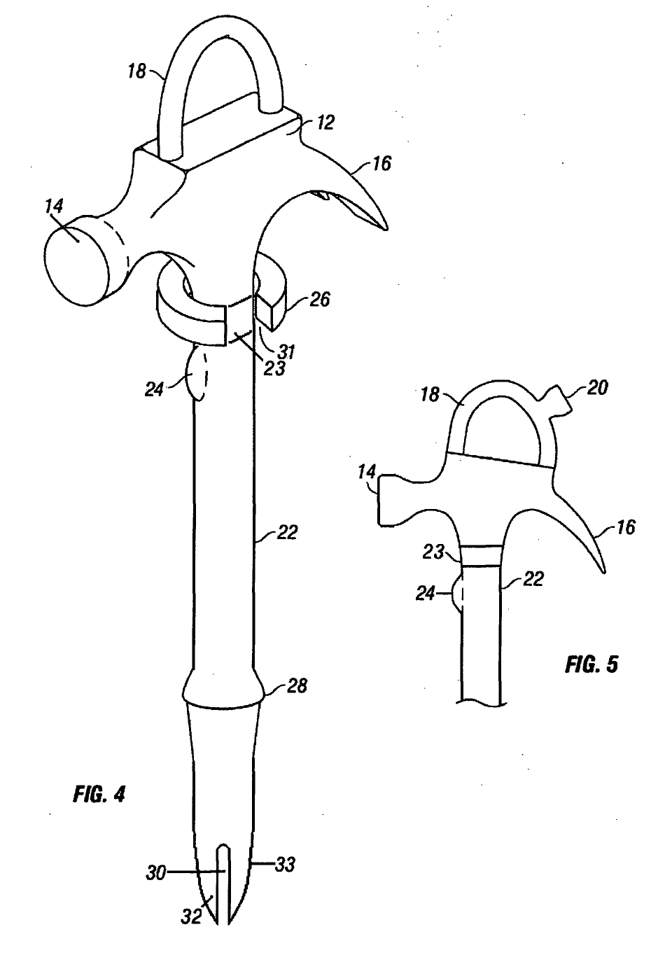

FIG. 4 illustrates the ring 26 held in place above the protrusion 24. In the alignment illustrated in FIG. 4, the cross-section of the handle 22 at the protrusion 24 is such that the inner diameter of the ring 26 will not pass over the protrusion 24 and is retained in the space 36 to prevent interference with the hand of a user. As previously described, the ring 26 can be passed over the protrusion 24 by rotating the ring 26 to align the notch 31 with the protrusion 24. Further, as described above, the ring 26 can be wholly removed from the elongate member 22 and reattached thereto by aligning the notch 31 with the depressed region 23 of the elongate member 22.

FIG. 5 illustrates an alternate embodiment of the tool 10 having a second striking surface 20 disposed on an end of the loop 18. The second striking surface 20 is shown as a generally flat portion of the loop 18. In an embodiment, the second striking surface 20 can be of a smaller and/or differing size than the face 14 of the head 12, and can therefore be used for making small adjustments to a nail or similar object. Further, orienting the second striking surface 20 in the manner shown in FIG. 5 enables driving a nail or striking an object without requiring rotation of the tool 10.

### Exemplary Operation of the Device

### Fence Stretcher/Wire Puller

The tool 10 as described herein provides a particular advantage in its compact design, its light weight, and its ability to perform various and multiple functions. Embodiments of the multi-purpose tool 10 are usable for many tasks, such as erecting wire fences and similar barricade systems. In one aspect, the multi-purpose tool 10 as described herein can be used to tension flexible members of a fence, such as lengths of barbed wire 34, chain links, or the like. Small gauge wire used in fencing, especially barbed wire 34, can injure the hands of an individual attempting to tension the wire by hand, even through protective gloves. In one aspect, the multi-purpose tool 10 can be used to tension fence wire, which prevents these injuries.

To use the multi-purpose tool 10 in this capacity, the ring 26 can be placed axially below the protrusion 24, as shown in FIG. 1. A length of barbed wire 34 is secured at a first end, i.e. to a fence post or similar vertical member, while the free end of the wire 34 is passed through the notch 31 of the ring 26. The inner diameter of the ring 26 and the outer diameter of the elongate member 22 are dimensioned to allow the wire 34 to fit therebetween. To apply tension to the wire 34, the tool 10 can be held by the head 12, by the elongate member 22, or by the loop 18 and pulled. The ring 26, which grips the wire 34 against the outer diameter of the handle 22, can axially move toward the stopper 28 during use, such that the conical shape of the ring stopper 28 grips the wire 34 against the inner diameter of the ring 26. As the tool 10 is pulled, the stopper 28 and the inner diameter of the ring 26 tightly grip the wire 34, such that lifting or otherwise raising the tool 10 tensions the wire.

### Hammer

The multi-purpose tool 10 as described herein can be used as a conventional hammer. As described above, the ring 26 can be placed in the small space 36 above the protrusion 24 by aligning the notch 31 with the protrusion 24, to prevent the ring 26 from interfering with use of the tool 10. Alternatively, the ring 26 can be removed by aligning the notch 31 with the depressed region 23 of the elongate member 22. Once the ring 26 is secured or removed, the tool 10 can be held by the elongate member 22 and swung such that the face 14 strikes a desired object, facilitated by the weight of the head 12.

### Claw

The claw 16 is usable to pull nails and similar objects by wedging the prongs of the claw 16 beneath the nail such that the head of the nail engages the slot between the prongs of the claw 16. The claw 16 is also usable to pry objects apart due to its generally wedge-shaped profile, and to impact objects in the manner of a pick.

### Pry Bar

The pry bar 32 similarly has a wedge shape, allowing it to be forced between objects. The elongate member 22 is usable as a handle, and provides leverage for prying such objects apart. The slot 30 of the pry bar 32 is also usable to remove nails and similar objects, in the manner described above.

### U Nail Puller

Embodiments of the tool 10 are also usable to pull U-shaped nails and staples. Such fasteners are often hammered securely into place, such as when installing a wire fence. Typically, the prongs of a conventional hammer claw are too wide to insert beneath a staple or a U-shaped nail. The slot 38 of the pry bar 32 can define two prongs 33 that are more narrow than those of a conventional hammer claw, and can thus be used to pull U-shaped nails, staples, and similar fasteners.

### Second Striking Surface

As illustrated in FIG. 5, the loop 18 can be provided with a second striking surface 20, which is operable in the same manner as the face 14. However, the second striking surface 20 provides an advantage, in that the tool 10 does not require reorientation when alternating between two tasks, such as both pulling and hammering nails. Additionally, in an embodiment, the second striking surface 20 can be smaller than the face 14 of the head 12, to enable final driving of nails and/or small adjustments to hammered nails.

### Additional Nail Pulling Leverage

The loop 18, as previously described, can be used to provide the tool 10 with additional leverage for pulling longer nails. The position, size, and configuration of the loop 18 can determine how much additional leverage is applied, and the length of nails that can be pulled. In use, the claw 16 can be engaged with a nail, as described above, by inserting the nail head between the prongs of the claw 16. Then the elongate member 22 can be pushed or pulled in order to pull the nail. The additional curvature of loop 18 increases the distance between the nail being pulled and the fulcrum of the tool 10, increasing the leverage applied to the claw 16, such that less movement of the elongate member 22 is required to effect a certain displacement of the claw 16 and nail.

### Loop as a Hooking Device

In addition to advantages as previously described relating to increased leverage and nail pulling power, the loop 18 is usable to catch hooks, such as when extending a “come-a-long” cable. During such a task, the tool 10 can then be gripped by the elongate member 22 and pulled. Use of the tool 10 in this manner can avoid injuries and overcome the general difficulties inherent when gripping and pulling cables. The loop 18 can also be used to hang the tool 10 from a belt, hook, or similar protruding member.

### Fence Tightener/Fence Twister

Once a barbed wire fence, for example, has been erected, each length of wire 34 must be provided with a desired tension. This tension is important for the integrity of the fence. Over time, the weight of the wire itself and other forces, such as those imparted by the wind, animals, humans, or various objects contacting the fence can stretch the wires and reduce the tension therein. The tool 10 is usable as a fence tightener to reestablish the desired tension in the fence wire. Specifically, the slot 30 of the pry bar 32 can be positioned to accept a length of wire 34 that is secured at both ends. The tool 10 can then be rotated about the elongate member 22. To the extent there is slack in the wire 34, the wire will begin to wrap around the end of the pry bar 32, and the slack in the wire 34 will be removed.

### Magnet

In one embodiment, a portion of, or the entire elongate member 22, the ring 26, or combinations thereof, can be formed from a magnetic material. The magnetic material can be used to pick up nails and other metallic objects that have been dropped out of view, such as in tall grass or into cracks or other separations in cement.

### Jack Handle

In an embodiment, the pry bar 32 of the tool 10 can be configured such that the wedge portion can interact with a jack. The elongate member 22 can be used to provide leverage for the tool 10 to be used as a jack handle. The pry bar 32 can be engaged with the jack and twisted or pushed to operate the jack. In one embodiment, the slot 30 of the pry bar 32 can engage a member within the jack, such that rotating the tool 10 can operate the jack. In another embodiment, the tool 10 can engage a portion of the jack and be moved vertically to operate the jack.

### Tie Down Handle

Embodiments of the tool 10 are also usable as a tie down handle. Tie downs are used in a number of fields, and typically include a long shaft for insertion into the ground with a loop, hole or other member disposed above for tying down objects such as tents, fences, canopies, trees, airplanes, and other similar objects. In use, tie downs are typically twisted into the ground, and the tool 10, in one embodiment, can be configured to act as a handle to aid in twisting the tie down. For example, the top of the tie down can be configured to receive the pry bar 32, such that the tool 10 can be rotated about the axis of the elongate member 22 to twist the tie down into the ground. In another embodiment, the pry bar 32 can be slid through an opening in the tie down, such that the elongate member 22 of the tool 10 is perpendicular to the shaft of the tie down. A user can then grip the pry bar 32 on one side, and the loop 18 or head 12 on the other side, and twist the tool 10 to screw the tie down into the ground.

Other uses features, and modifications to the specific embodiments of the multi-purpose tool described herein can also be practiced, as would be understood in the art. Embodiments of the present invention thereby provide a compact and portable tool usable to perform a variety of tasks with greater efficacy than conventional counterparts.

What is claimed is:

1. A multi-purpose tool comprising:
an elongate member comprising a protrusion extending from a surface thereof; and
a ring disposed around the elongate member, wherein the ring comprises a notch, wherein the ring freely moves axially along the elongate member and rotates about the elongate member, and wherein the protrusion is sized to permit the ring to pass over the protrusion when the notch is aligned with the protrusion.

2. The multi-purpose tool of claim 1, further comprising a head mounted to an end of the elongate member, wherein the head comprises a striking surface, a claw, or combinations thereof.

3. The multi-purpose tool of claim 1, further comprising a pry bar disposed at an end of the elongate member, wherein the pry bar comprises at least one sidewall.

4. The multi-purpose tool of claim 1, further comprising a stopper disposed along the elongate member, wherein the stopper is sized to prevent axial movement of the ring beyond the stopper.

5. The multi-purpose tool of claim 1, further comprising a loop formed at an end of the tool, wherein the loop is sized for engaging a member of a fence.

6. The multi-purpose tool of claim 5, wherein the loop comprises a striking surface formed on an external portion thereof.

7. The multi-purpose tool of claim 1, wherein the elongate member comprises a depression, and wherein the ring is removable from the elongate member when the notch is aligned with the depression.

8. The multi-purpose tool of claim 1, wherein at least one of the ring and the elongate member is magnetized, and wherein the other of the ring and the elongate member is formed from a magnetically attractive material.

9. A multi-purpose tool comprising:
an elongate member comprising a protrusion extending therefrom and a depression formed therein; and
a ring disposed around the elongate member, wherein the ring comprises a notch, wherein the ring freely moves axially along the shaft and rotates about the shaft, wherein the protrusion is sized to permit the ring to pass over the protrusion when the notch is aligned with the protrusion, and wherein the ring is removable from the elongate member when the notch is aligned with the depression.

10. The multi-purpose tool of claim 9, further comprising a head mounted to an end of the elongate member, wherein the head comprises a striking surface, a claw, a loop or combinations thereof.

11. The multi-purpose tool of claim 9, further comprising a pry bar disposed at an end of the elongate member, wherein the pry bar comprises at least one sidewall.

12. The multi-purpose tool of claim 9, further comprising a stopper disposed along the elongate member, wherein the stopper is sized to prevent axial movement of the ring beyond the stopper.

13. The multi-purpose tool of claim 9, further comprising a loop formed at an end of the tool, wherein the loop is sized for engaging a member of a fence.

14. The multi-purpose tool of claim 13, wherein the loop comprises a striking surface formed on an external portion thereof.

15. The multi-purpose tool of claim 9, wherein at least one of the ring and the elongate member is magnetized, and wherein the other of the ring and the elongate member is formed from a magnetically attractive material.

16. A method for tensioning a flexible member with a multi-purpose tool, the method comprising the steps of:
providing a multi-purpose tool comprising an elongate member having a protrusion and a ring disposed around the elongate member, wherein the ring comprises a notch, wherein the ring freely moves axially along the shaft and rotates about the shaft, and wherein the protrusion is sized to permit the ring to pass over the protrusion when the notch is aligned with the protrusion;
securing a first end of the flexible member;
inserting a portion of the flexible member through the notch of the ring;
securing the portion of the flexible member between an inner surface of the ring and an outer surface of the elongate member; and
pulling the multi purpose tool away from the first end of the flexible member to apply tension to the flexible member.

17. The method of claim 14, wherein the step of securing the portion of the flexible member between the inner surface of the ring and the outer surface of the shaft comprises axially moving the ring along the elongate member to contact a stop formed in the elongate member, wherein the portion of the flexible member is contacted by the stop and the inner surface of the ring.

18. The method of claim 14, wherein the step of securing the first end of the flexible member comprises engaging the first end of the flexible member with a member of a fence.

19. The method of claim 16, further comprising the step of engaging the member of the fence with a loop formed at an end of the elongate member and straightening the member of the fence using the loop.

20. The method of claim 16, further comprising the step of removing the ring from the elongate member by aligning the notch of the ring with a depression in the elongate member and passing the depression of the elongate member through the notch.
